(19) United States
(12) Patent Application Publication
(10) Pub. No.: US 2025/0273196 A1
(43) Pub. Date: Aug. 28, 2025

(54) METHOD OF GENERATING SPEECH BASED ON NORMALIZING FLOW MODEL THAT GENERATES TIMBRE FROM TEXT

(71) Applicant: POSTECH RESEARCH AND BUSINESS DEVELOPMENT FOUNDATION, Pohang-si (KR)

(72) Inventors: Young Joo SUH, Pohang-si (KR); Ji O GIM, Pohang-si (KR)

(21) Appl. No.: 19/039,252

(22) Filed: Jan. 28, 2025

(30) Foreign Application Priority Data
Feb. 26, 2024 (KR) 10-2024-0027572

(51) Int. Cl. G10L 13/04; G10L 25/63

(52) U.S. Cl. CPC G10L 13/04; G10L 25/63

(57) ABSTRACT

A method of generating synthetic speech data includes acquiring, by a data processing device, text data and speech data; extracting, by the data processing device, timbre information from the text data, and generating, by the data processing device, synthetic speech data based on the timbre information and the speech data.

### CROSS-REFERENCE TO RELATED APPLICATION

This application claims priority to and the benefit of Korean Patent Application No. 10-2024-0027572, filed on Feb. 26, 2024, the disclosure of which is incorporated herein by reference in its entirety.

### BACKGROUND

### 1. Field of the Invention

The present invention relates to a speech synthesis technology.

### 2. Discussion of Related Art

Speech transformation technology is a technology that changes the characteristics of speech. Speech modulation technology is a technology that changes the characteristics of speech by adjusting various factors such as frequency, pitch, and intensity of a digitalized speech signal. Speech transformation technology can be used in various technical fields.

Speech conversion technology is a technology that converts the speech of one person (source speaker) into the speech of another person (target speaker). Speech conversion technology is a technology that converts the characteristics of the speech such as timbre, pitch range, and rhythm into the speech characteristics of another person while maintaining the linguistic content of the speech.

### RELATED ART DOCUMENTS

### Non-Patent Document

Rezende, et al., “Variational Inference with Normalizing Flows,” 2015.

### SUMMARY OF THE INVENTION

There have been conventional speech conversion technologies based on text-to-speech (TTS). However, such TTS-based speech conversion technologies have not been suitable for fields requiring real-time communication. This is because typing speech into text is highly inefficient. In addition, in end-to-end technologies that transition from speech to speech, it is possible to convert speech into a pre-trained timbre, but it is difficult to immediately convert speech into a desired timbre using a prompt.

There have also been conventional technologies that generate speech with a desired timbre by receiving text expressing a timbre using prompts. However, such conventional speech generation methods required users to input prompts according to predetermined standards rather than allowing the users to input prompts freely. For example, these conventional methods often required the prompts to include factors such as gender, sound, tone, speech rate, and emotion. Alternatively, in the conventional speech generation methods, it was necessary to input prompts that were only limited to text related to the speech style. These conventional methods reduced users' freedom in inputting prompts.

The technology described below is intended to provide a method of generating synthetic speech data by receiving text and speech data in a free format.

The technology described below discloses a method of generating synthetic speech data. The present invention is directed to a method of training a normalizing flow-training model used in a method of generating synthetic speech data.

According to an aspect of the present invention, there is provided a method of generating synthetic speech data, which includes acquiring, by a data processing device, text data and speech data; extracting, by the data processing device, timbre information from the text data; and generating, by the data processing device, synthetic speech data based on the timbre information and the speech data.

According to another aspect of the present invention, there is provided a method of training a normalizing flow-training model, which includes acquiring, by a data processing device, training speech data and training text data; generating, by the data processing device, a reference timbre embedding vector from the training speech data using a timbre information extractor; generating, by the data processing device, a sentence embedding vector from the training text data using a context information extractor; generating, by the data processing device, a timbre embedding vector from the sentence embedding vector using a normalizing flow-training model; calculating, by the data processing device, a loss value between the reference timbre embedding vector and the timbre embedding vector; and updating, by the data processing device, a parameter of the normalizing flow-training model so that the calculated loss value is minimized.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating an overall process of a data processing device 100 performing a method of generating synthetic speech data.

FIG. 2 is a flowchart 200 illustrating an embodiment of generating synthetic speech data.

FIG. 3 is a diagram illustrating one embodiment in which a data processing device generates synthetic speech data.

FIG. 4 is a diagram illustrating one embodiment of training a normalizing flow-training model.

FIG. 5 is a diagram illustrating one embodiment of a normalizing flow-training model structure.

FIG. 6 is a diagram illustrating a configuration of one embodiment of a data processing device 300.

### DETAILED DESCRIPTION OF EXEMPLARY EMBODIMENTS

The technology described below can have various modifications and various embodiments. Specific embodiments of the technology described below may be described in the drawings of the specification. However, this is for the purpose of explaining the technology described below and is not intended to limit the technology described below to a specific embodiment. Therefore, it should be understood that all modifications, equivalents, or substitutes included in the idea and scope of the technology described below are included in the technology described below.

Although terms such as “first,” “second,” “A,” “B,” etc., may be used to describe various components, these components are not to be limited by these terms, and the terms are only used to distinguish one component from another component. For instance, a “first” component may be named a “second” component, and similarly, a “second” component may also be referred to as a “first” component, without departing from the scope of the technology to be described below. The term “and/or” includes a combination of a plurality of related listed items or any of a plurality of related listed items.

In the terms used herein, the singular forms are intended to include plural forms as well, unless the context clearly indicates otherwise, and it will be further understood that terms such as “comprise,” “include,” etc., specify the presence of stated features, integers, steps, operations, components, parts, or combinations thereof, but do not preclude the presence or addition of one or more other features, integers, steps, operations, components, parts, or combinations thereof.

Before the drawings are described in detail, it should be clarified that the classification of the constituent units in the present specification is merely a division depending on the main function that each constituent unit is responsible for. Specifically, two or more constituent units to be described below may be combined into one constituent unit, or one constituent unit may be divided into two or more for each subdivided function. Furthermore, it will be understood that each of the constituent units to be described below may additionally perform some or all of the functions of other constituent units in addition to the main function it is responsible for and also that some of the main functions that the constituent units are responsible for may be exclusively performed by other constituent units.

Moreover, in performing the method or operation method, individual processes constituting the method may occur differently from the specified order unless a specific order is clearly described in context. Specifically, individual processes may occur in the same order as specified, may be performed substantially simultaneously, or may be performed in reverse order.

Hereinafter, an overall process of a data processing device performing a method of generating synthetic speech data will be described.

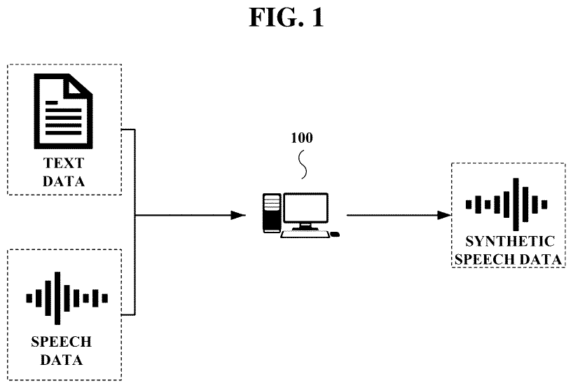

FIG. 1 is a diagram illustrating an overall process of a data processing device 100 performing a method of generating synthetic speech data.

The data processing device 100 can be physically implemented in various forms. For example, the data processing device 100 may have the form of a PC, a laptop, a smart device, a server, or a data processing chipset.

The data processing device 100 may exist singly or in plurality. That is, the aforementioned method of generating synthetic speech data may be performed by at least one data processing device 100.

The data processing device 100 may be a device that performs the method of generating synthetic speech data. The data processing device 100 may acquire text data and speech data. The data processing device 100 may extract timbre information from the text data. The data processing device 100 may generate synthetic speech data based on the extracted timbre information and speech data. The data processing device 100 may output the generated synthetic speech data.

Hereinafter, a method of generating synthetic speech data will be described in more detail.

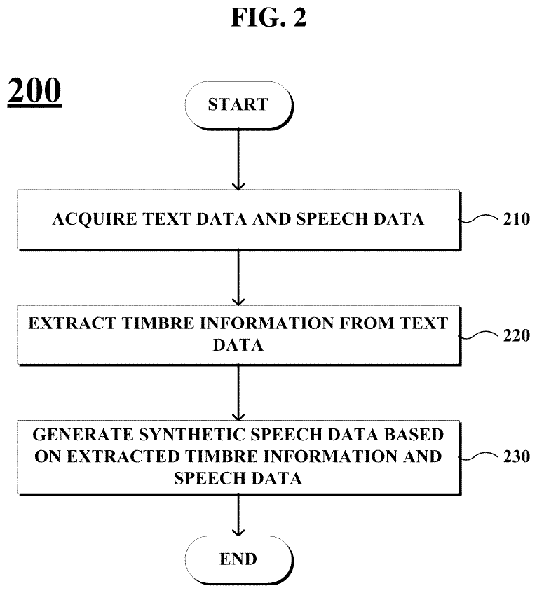

FIG. 2 is a flowchart 200 illustrating one embodiment of generating synthetic speech data.

The data processing device may acquire text data and speech data in operation 210.

The text data may be data that expresses the timbre of speech to be synthesized as text.

The text data may include text that embodies the mood of a speaker through timbre. At this time, the text data does not necessarily need to include text related to the speech style. This is because a normalizing flow-training model that will be described later is used. Therefore, since the text data does not have a special format, the user's freedom in prompt input can be increased.

The speech data may include speech to be converted. In other words, the speech data may include speech spoken by a speaker.

The speech data may include data in the form of a waveform.

The text data may be input to the data processing device in advance. On the other hand, the speech data may be input to the data processing device in real time. Therefore, the data processing device may extract and store timbre information for the text data input in advance, and then generate synthetic speech data from the speech data input in real time. If necessary, the data processing device may receive various types of text data in advance, extract and store various types of timbre information from the received text data, and then utilize the extracted and stored information.

The data processing device may extract timbre information from the text data in operation 220.

As described above, the text data may be data that expresses the timbre of speech to be synthesized as text. Therefore, the timbre information can be extracted from the text expressed in the text data. The timbre information has information on the timbre expressed as text in the text data.

The timbre information may include a timbre embedding vector.

The timbre embedding vector may be extracted from the text data using a context information extractor and a normalizing flow-training model.

The context information extractor may be a pre-trained natural language processing (NLP) model. The context information extractor may numerically express the meanings of sentences expressed in the text data. The context information extractor may map text to a sentence embedding space by considering the semantic and syntactic characteristics of the sentences.

The context information extractor may extract a sentence embedding vector from the text data. In one embodiment, the context information extractor may convert each sentence expressed in the text data into a separate high-dimensional vector.

The normalizing flow-training model may be a model based on the idea of change of variable theorem. The normalizing flow-training model may be a model that converts the distribution of data into a simple distribution such as a Gaussian distribution using a function that can be inverted.

The normalizing flow-training model may generate a timbre embedding vector from the sentence embedding vector. In other words, the normalizing flow-training model may map the sentence embedding vector in the sentence embedding space to the timbre embedding vector in a timbre embedding space.

The normalizing flow-training model may be a model that converts input data into a simple low-dimensional probability distribution and then maps the probability distribution to a complex high-dimensional probability distribution based on the converted result. In other words, the normalizing flow-training model generates a low-dimensional latent vector from the input sentence embedding vector (forward transformation) and generates the timbre embedding vector through the generated latent vector (reverse transformation).

Through the normalizing flow-training model, even complex data distribution can be efficiently trained, and high performance can be achieved with less data. In addition, efficient parallel processing is possible through the normalizing training model, which can greatly save computer resources.

The data processing device may generate synthetic speech data based on the extracted timbre information and speech data in operation 230.

The data processing device may input the timbre information and speech data to a decoder to generate synthetic speech data. Specifically, the data processing device may input the timbre embedding vector and the sentence embedding vector into the decoder to generate the synthetic speech data.

The synthetic speech data may be speech data in which the timbre of the input speech data is converted into the timbre expressed in the text data.

Furthermore, the data processing device may output the generated synthetic speech data.

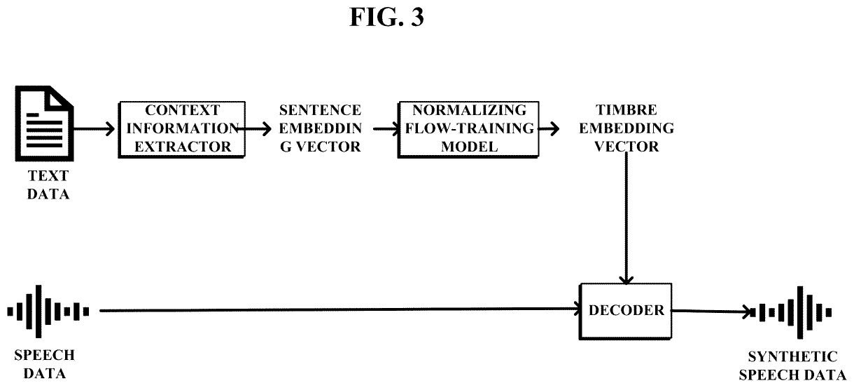

FIG. 3 is a diagram illustrating one embodiment in which a data processing device generates synthetic speech data.

The data processing device may acquire text data and speech data. The data processing device may acquire the text data through an input unit such as a keyboard. The data processing device may acquire the speech data through an input unit such as a microphone.

The context information extractor extracts a sentence embedding vector from the text data. If necessary, the sentence embedding vector may further pass through a projection layer.

The sentence embedding vector may be input to a normalizing flow-training model. The normalizing flow-training model outputs a timbre embedding vector having timbre information from the sentence embedding vector.

The acquired speech data may be converted into waveform data. The speech data converted into the waveform data and the timbre embedding vector may be input to a decoder. The decoder may generate synthetic speech data based on the speech data and the timbre embedding vector. The generated synthetic speech data may be data converted from a user's speech into a new timbre. The generated synthetic speech data may be output through an output unit such as a speaker.

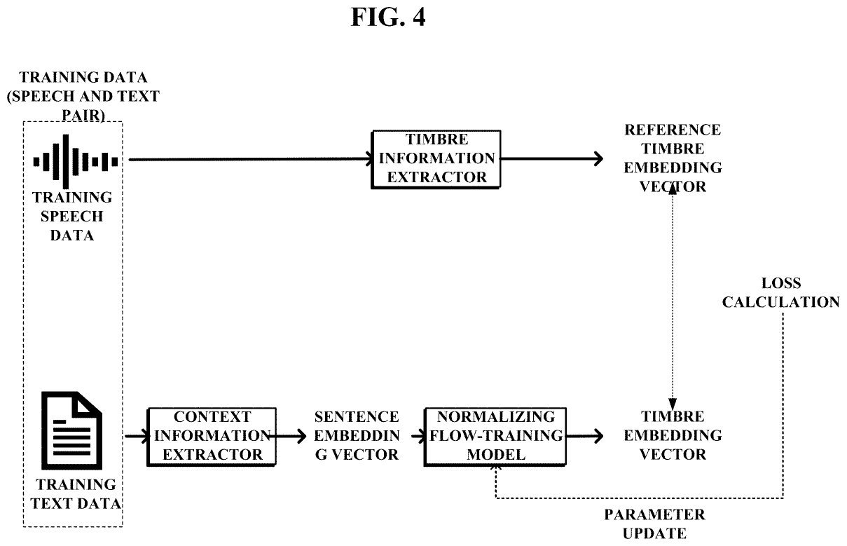

FIG. 4 is a diagram illustrating one embodiment of training a normalizing flow-training model.

Training data is used for the normalizing flow-training model. The training data includes training speech data and training text data. The training speech data and the training text data are paired with each other. In one embodiment, the training text data may express the timbre appearing in the speech of the training speech data, as text.

The training speech data may be input to a timbre information extractor. The timbre information extractor may generate a reference timbre embedding vector from the training speech data. The reference timbre embedding vector represents timbre information included in the training speech data. The reference timbre embedding vector may serve as reference data.

The training text data may be input to a context information extractor. The context information extractor may generate a sentence embedding vector from the training text data. The sentence embedding vector represents context in a sentence unit, which is included in the training text data.

The reference timbre embedding vector and the sentence embedding vector may have the same dimensions. For this purpose, a projection layer may be used. For example, the projection layer may be placed after the context information extractor or the timbre information extractor to unify the dimensions of the reference timbre embedding vector and the sentence embedding vector.

The sentence embedding vector may be input to the normalizing flow-training model. The normalizing flow-training model may generate a timbre embedding vector from the sentence embedding vector. The normalizing flow-training model receives the sentence embedding vector and maps the sentence embedding space to the timbre embedding space. In other words, the normalizing flow-training model may map the sentence embedding vector to the timbre embedding vector.

A loss value between the calculated timbre embedding vector and the reference timbre embedding vector may be calculated. Parameters of the normalizing flow model may be updated so that the calculated loss value is minimized. Through this, the timbre embedding vector generated by the normalizing flow-training model may have the timbre information expressed by the data in the training text.

Training of the normalizing flow-training model may be performed by a service provider. In one embodiment, the normalizing flow-training model may be trained in advance through the server of the service provider.

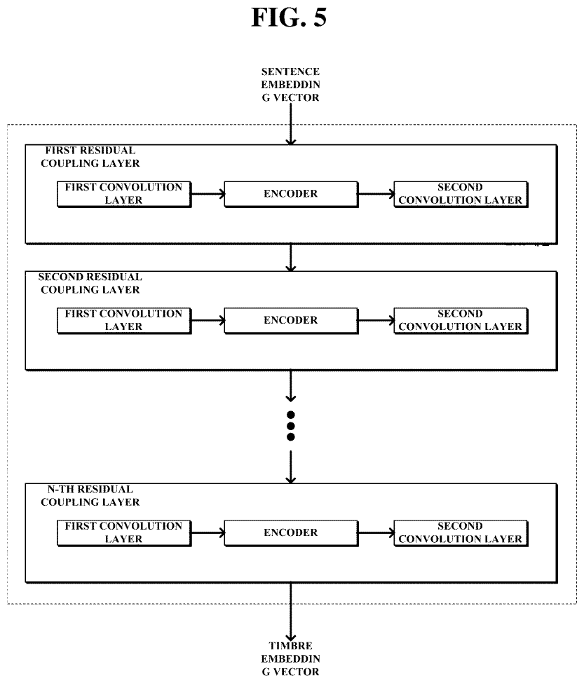

FIG. 5 is a diagram illustrating one embodiment of a normalizing flow-training model structure.

The normalizing flow-training model uses a residual block. The normalizing flow-training model is composed of affine coupling layers.

The normalizing flow-training model may include a plurality of residual coupling layers. Each residual coupling layer may include a first convolution layer, an encoder, and a second convolution layer.

The sentence embedding vector input to the normalizing flow model passes through the residual coupling layer of the normalizing flow model. Specifically, the sentence embedding vector passes through the first convolution layer, the encoder, and the second convolution layer included in the residual coupling layer.

In this manner, the sentence embedding vector passes through the plurality of residual coupling layers included in the normalizing flow model to become the timbre embedding vector. Accordingly, the timbre embedding vector may be output. Specifically, a latent vector is generated through forward transformation from the sentence embedding vector, and the timbre embedding vector is generated through reverse transformation from the generated latent vector.

Hereinafter, a data processing device will be described.

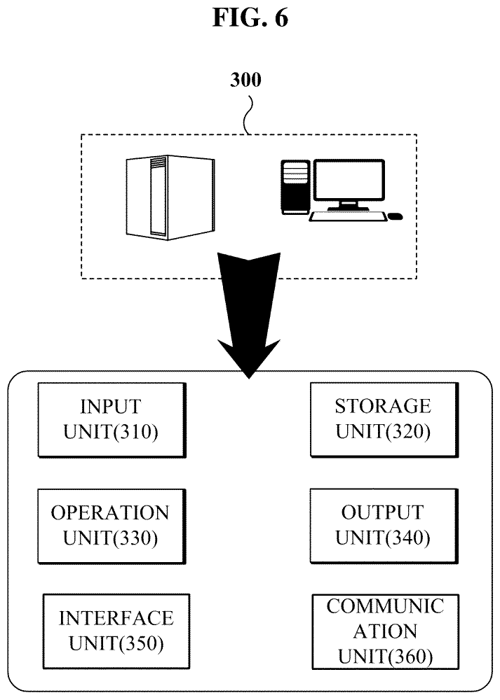

FIG. 6 is a diagram illustrating a configuration of one embodiment of a data processing device 300.

The data processing device 300 may correspond to the data processing device 100 described in FIG. 1. In other words, the data processing device 300 may be a device that performs the aforementioned method of generating synthetic speech data.

The data processing device 300 may include at least one input unit 310, a storage unit 320, an operation unit 330, an output unit 340, an interface unit 350, and a communication unit 360.

The input unit 310 may receive data, information, or models necessary for performing the aforementioned method for generating synthetic speech data. The input unit 310 may receive speech data, text data, and training data. The input unit 310 may receive a normalizing flow-training model.

The input unit 310 may include a device (keyboard, mouse, touch screen, joystick, trackball, touchpad, scanner, webcam, microphone, recorder, etc.) for inputting certain commands or data. The input unit 310 may include a component for receiving data through a separate storage unit (USB, CD, hard disk, etc.). The input unit 310 may also receive data through a separate measuring device or a separate database. The input unit 310 may also receive data through a communication unit 360 in a wired or wireless manner. The input unit 310 may also receive a control signal for controlling the data processing device 300.

The storage unit 320 may store data, information, or models, etc., required to perform the aforementioned method of generating synthetic speech data. The storage unit 320 may store speech data, text data, and training data. The storage unit 320 may store the normalizing flow-training model. The storage unit 320 may be a device that stores certain data, information, or models, etc. The storage unit 320 may store data, information, and models input through the input unit 310. The storage unit 320 may store instructions that cause the operation unit 330 to perform operations necessary for the method of generating synthetic speech data. The storage unit 320 may store information generated during the operation of the operation unit 330. That is, the storage unit 320 may include a memory. For example, the storage unit may include a hard disk drive (HDD), a solid state drive (SSD), a ROM, a RAM, a CD-ROM, a magnetic tape, or a floppy disk.

The operation unit 330 may perform operations required to perform the aforementioned method for generating synthetic speech data. The operation unit 330 may acquire text data and speech data. The operation unit 330 may extract timbre information from the text data. The operation unit 330 may generate synthetic speech data based on the timbre information and the speech data. The operation unit 330 may be a device that processes data and processes certain operations, such as a processor, an application processor (AP), or a chip embedded with a program. For example, the operation unit 330 may include a central processing unit (CPU), a graphics processing unit (GPU), or a neural processing unit (NPU). The operation unit 330 may generate a control signal that controls the data processing device 300. The operation unit 330 may generate a control signal that controls the input unit 310, the storage unit 320, the output unit 340, the interface unit 350, and the communication unit 360 included in the data processing device 300.

The output unit 340 may be a device that outputs certain data, information, and models. The output unit 340 may be a device that outputs certain data, information, and models to the outside of the data processing device 300. The output unit 340 may output interfaces, input data, analysis results, etc., required for the data processing process. The output unit 340 may include a device that outputs data, etc., through tactile, visual, auditory, gustatory, and olfactory methods. The output unit 340 may be implemented in various physical forms, such as a display, a speaker, a vibration motor, or a document output unit. The output unit 340 may output data, information, or models stored in the storage unit 320. The output unit 340 may output data, information, and models generated during the operation of the operation unit 330. The output unit 340 may output the results of the operation of the operation unit 330.

The interface unit 350 may be a device that receives certain commands and data from the outside. The interface unit 350 may receive a control signal for controlling the data processing device 300. The interface unit 350 may output the results analyzed by the data processing device 300. The interface unit 350 may receive information necessary for performing the aforementioned method of generating synthetic speech data from a physically connected input unit or an external storage unit.

The communication unit 360 may receive information necessary for performing the aforementioned method of generating synthetic speech data. The communication unit 360 may receive a model necessary for performing the aforementioned method of generating synthetic speech data. The communication unit 36 may transmit and receive speech data, text data, and training data. The communication unit 360 may transmit and receive a normalizing flow-training model. The communication unit 360 may receive a control signal necessary to control the data processing device 300. The communication unit 360 may transmit the results analyzed by the data processing device 300. The communication unit 360 may be a component that receives and transmits certain data, information, models, etc., through a wired or wireless network. The communication unit 360 may perform network communication such as wireless fidelity (Wi-Fi), Wi-Fi direct, Bluetooth, ultra-wide band (UWB), near field communication (NFC), Universal Serial Bus (USB), or High-Definition Multimedia Interface (HDMI), a local area network (LAN), etc.

The above-described method of generating synthetic speech data can be implemented as a program (or application) including an executable algorithm that can be executed on a computer.

The program may be stored in a non-transitory computer readable medium and provided.

The above-mentioned non-transitory computer readable medium may be any of various RAMs such as a static RAM (SRAM), a dynamic RAM (DRAM), a synchronous DRAM (SDRAM), a double data rate SDRAM (DDR SDRAM), an enhanced SDRAM (ESDRAM), a synchronous DRAM (Sync-link DRAM, SLDRAM), and a direct Rambus RAM (DRRAM).

The above non-transitory computer readable medium is a medium that semi-permanently stores data and can be read by a device, rather than a medium that stores data for a short period of time, such as a register, cache, or memory. Specifically, the various applications or programs described above may be stored and provided in a non-transitory computer readable medium, such as a CD, DVD, hard disk, Blu-ray disk, USB, memory card, read-only memory (ROM), programmable read only memory (PROM), erasable PROM (EPROM), electrically EPROM (EEPROM), or flash memory.

As described above, using the technology described below, synthetic speech data can be generated based on text data and speech data. In particular, by allowing text expressing timbre to be included in the text data, speech with a desired timbre can be generated. In addition, the text expressing timbre can be freely written without having to follow a separate standard.

The technology described below can be applied to real-time calls and video production, etc. For example, dubbing narration can be produced and inserted into a video using the technology described below. In particular, using the technology described below, speech with a desired timbre can be generated without copyright-related concerns or the hiring of a separate voice actor.

The embodiment described in the present specification and the accompanying drawings is merely illustrative of a part of the technical ideas included in the present disclosure. The modified examples and specific examples which can be readily inferred by a person skilled in the art within the scope of the technical ideas included in the specification and drawings of the present disclosure are to be construed as being included in the scope of the present disclosure.

What is claimed is:

1. A method of generating synthetic speech data, comprising:
acquiring, by a data processing device, text data and speech data;
extracting, by the data processing device, timbre information from the text data; and
generating, by the data processing device, synthetic speech data based on the timbre information and the speech data.

2. The method of generating synthetic speech data of claim 1, wherein the text data includes text that embodies a speaker's mood through timbre.

3. The method of generating synthetic speech data of claim 1, wherein
the timbre information includes a timbre embedding vector,
the timbre embedding vector is extracted from the text data using a context information extractor and a normalizing flow-training model,
the context information extractor extracts a sentence embedding vector from the text data, and
the normalizing flow-training model extracts the timbre embedding vector from the sentence embedding vector.

4. The method of generating synthetic speech data of claim 3, wherein the context information extractor includes a pre-trained natural language processing (NLP) model.

5. The method of generating synthetic speech data of claim 3, wherein the normalizing flow-training model is a model based on the change of variable theorem, and generates a low-dimensional latent vector from the sentence embedding vector and generates the timbre embedding vector from the generated latent vector.

6. The method of generating synthetic speech data of claim 3, wherein the generating of the synthetic speech data includes generating the synthetic speech data by inputting the timbre embedding vector and the sentence embedding vector into a decoder.

7. The method of generating synthetic speech data of claim 1, further comprising:
outputting, by the data processing device, the generated synthetic speech data.

8. A data processing device comprising:
an input unit configured to acquire text data and speech data;
an operation unit configured to extract timbre information from the text data and generate synthetic speech data based on the timbre information and the speech data; and
an output unit configured to output the generated speech data.

9. A method of training a normalizing flow-training model, the method comprising:
acquiring, by a data processing device, training speech data and training text data;
generating, by the data processing device, a reference timbre embedding vector from the training speech data using a timbre information extractor;
generating, by the data processing device, a sentence embedding vector from the training text data using a context information extractor;
generating, by the data processing device, a timbre embedding vector from the sentence embedding vector using a normalizing flow-training model;
calculating, by the data processing device, a loss value between the reference timbre embedding vector and the timbre embedding vector; and
updating, by the data processing device, a parameter of the normalizing flow-training model so that the calculated loss value is minimized.

10. The method of claim 9, wherein the training text data includes text expressing timbre that appears in the training speech data.

11. The method of claim 10, wherein the reference timbre embedding data and the timbre embedding vector are passed through a projection layer and have the same dimensions.
